(19) United States
(12) Patent Application Publication
(10) Pub. No.: US 2005/0221065 A1
(43) Pub. Date: Oct. 6, 2005

(54) Multi-layer materials for producing packagings

(76) Inventors: Bernd Bruchmann, Freinsheim (DE); Joelle Bedat, Strasbourg (FR); Jurgen Kaczun, Niederkirchen (DE); Peter Poganiuch, Neustadt (DE); Eva Wagner, Darmstadt (DE); Jean-Francois Stumbe, Strasbourg (FR)

Correspondence Address: NIXON & VANDERHYE, PC, 901 NORTH GLEBE ROAD, 11TH FLOOR, ARLINGTON, VA, 22203, US

(21) Appl. No.: 10/510,747

(22) PCT Filed: Apr. 25, 2003
(86) PCT No.: PCT/EP03/04286

§ 371 Date: Oct. 12, 2004

(30) Foreign Application Priority Data
Apr. 30, 2002 (DE) 102 19 462

(51) Int. Cl. B32B 3/00

(52) U.S. Cl. 428/204

(57) ABSTRACT

Multilayer materials for producing packaging, comprising at least 2 films and a layer printed with a printing ink, the printing ink comprising a hyperbranched polyurea containing functional groups; a printing ink comprising a polyurea containing functional groups; and the use of said printing ink for producing multilayer materials.

The invention relates to multilayer materials for producing packaging comprising at least two films and also a layer which is printed with a printing ink, said printing ink comprising a hyperbranched polyurea containing functional groups. The invention further relates to a printing ink which comprises a hyperbranched polyurea containing functional groups, and to the use of said printing ink for producing multilayer materials.

Multilayer materials for producing packaging, especially food packaging, are known. As examples mention may be made of EP-A 695 329, EP-A 707 956, EP 802 045, EP-A 1 008 442 or EP-A 1 162 060. Multilayer materials of this kind are composed of two or more polymer films, polyolefin films for example, metal foils or metallized polymer films, which are joined to one another, for example, by lamination and with the aid of suitable laminating adhesives. The films (incl. foils) may each be monolayer or multilayer films produced by coextrusion. The laminates may further comprise other functional layers, examples being odor barrier layers or water vapor barriers.

Multilayer materials for producing packaging are normally printed or coated. The printing ink may be applied to the surface of the multilayer material or else may be between two films. Printing varnishes are either applied to the print substrate as a primer or applied to the print substrate after printing, as a protective coating. Printing varnishes contain no colorant, but apart from that are generally similar in their composition to printing inks.

The requirements imposed on printing varnishes and printing inks which are suitable for producing multilayer packaging materials are diverse. When printing onto nonabsorbent print substrates such as polymer films or metal foils, the printing ink cannot of course penetrate into the substrate, but instead leaves a dried film on the substrate after the solvent has evaporated. Printing inks for such substrates must therefore have very good film-forming properties and also especially good adhesive strength, so that the print film does not detach from the substrate under mechanical stress. Since laminates frequently contain films which differ from one another chemically, examples being polar polyamide or PET films and apolar polyolefin films, suitable printing inks are also required to adhere equally well to different kinds of substrates.

Printing inks comprising conventional binders lack sufficient strength of adhesion to numerous print substrates, and so it is necessary to add adhesion promoters such as certain silanes or titanates. By way of example, reference may be made here to U.S. Pat. No. 5,646,200. Even with the addition of adhesion promoters, however, the adhesion is not satisfactory on all print substrates, and so the films of multilayer composite materials may part from one another. Since multilayer composite materials are frequently used in the food sector, there is a further, general desire as far as possible to avoid low molecular mass constituents in printing ink formulas. This is desirable anyway on economic grounds.

Dendrimers, arborols, starburst polymers, and hyperbranched polymers are designations for polymeric structures which feature a branched structure with numerous branching sites and a high functionality. Dendrimers are molecularly uniform macromolecules having a highly symmetrical structure. However, they can only be synthesized with great complexity in syntheses comprising a large number of stages, and as a consequence are available only in small amounts and at very great cost.

In contrast, hyperbranched polymers are nonuniform both molecularly and structurally. They contain arms which differ in length and branching. Hyperbranched polymers can be synthesized using what are known as ABₓ monomers. These monomers contain two different functional groups, A and B, which are able to react with one another to form a link. The functional group A is present only once per molecule and the functional group B is present two or more times. The reaction of said ABₓ monomers with one another produces uncrosslinked polymers with regularly arranged branching sites. The polymers contain almost exclusively B groups at the chain ends. Further details are disclosed, for example, in J.M.S.—Rev. Macromol. Chem. Phys., C37(3), 555-579 (1997).

Highly functional polymers containing urea groups are known in principle, for example, from WO 98/50453 or from the as yet unpublished German application DE 102 04 979.3. Multilayer materials comprising polyureas of this kind have not been disclosed to date.

It is an object of the invention to provide multilayer materials for producing packaging, which exhibit improved adhesion between the individual films. A particular object is to provide multilayer materials which comprise polar films and exhibit improved adhesion between the individual films. A further object is to provide printing inks and printing varnishes suitable for this purpose which also contain as small as possible an amount of low molecular mass components and which can be prepared inexpensively.

We have found that this object is achieved by multilayer materials for producing packaging, comprising at least
one film 1 of a polymeric material,
one print layer obtainable by printing or coating with a printing ink,
one further film 2,
   the printing ink comprising as binder at least one hyperbranched polyurea containing functional groups selected from the group consisting of amino, OH, and blocked isocyanate groups.

The invention secondly provides a printing ink for flexographic and/or gravure printing which comprises at least one solvent or a mixture of different solvents, at least one colorant, at least one polymeric binder, and, optionally, additives. as well, at least one of the polymeric binders comprising a hyperbranched polyurea containing functional groups selected from the group consisting of amino, OH⁻, and blocked isocyanate groups.

The invention further provides for the use of said printing ink for printing polymer films or metal foils and for producing multilayer materials.

The invention thirdly provides printing varnishes which comprise at least one solvent or a mixture of different solvents, at least one polymeric binder, and, optionally, additives as well, at least one of the polymeric binders being a hyperbranched polyurea containing functional groups selected from amino, OH, and blocked isocyanate groups. It also provides for their use for priming, as a protective coating, and for producing multilayer materials.

Through the use of printing inks and printing varnishes with hyperbranched polyureas containing amino, OH or blocked isocyanate groups as binders, surprisingly, laminates featuring outstanding adhesion between the individual layers are obtained. The addition of adhesion promoters is no longer necessary. Particularly surprising and unexpected, even for the skilled worker, is that the results obtained without adhesion promoters are in fact better than when adhesion promoters are added. On polar films in particular it was possible to improve the adhesion substantially.

Details of the invention are set out below.

The film 1 for the multilayer material is composed of a polymeric material. Films suitable for packaging materials are published, for example, in Ullmann's Encyclopedia of Industrial Chemistry, 6^{th} Edt., 2000, Electronic Release. They include, for example, polyolefin films such as films of polyethylene, polypropylene or poly(4-methyl-1-pentene) or polystyrene. Polyethylene films may be films of HDPE, LDPE or LLDPE. They may be copolymers such as, for example, films of ethylene-vinyl acetate copolymers, ethylene-acrylic acid copolymers or styrene/butadiene copolymers. It is also possible to use films of PVC or polycarbonates. Moreover, films of polar materials may be used, examples being cellophane films, polyester films, such as those of polyethylene terephthalate, polybutylene terephthalate or polyethylene naphthalate, for example, or polyamide films, such as films of PA 6, PA 12, PA 6/66, PA 6/12 or PA 11, for example.

Film 1 is preferably a film of polyethylene, polypropylene, polystyrene, polyester or polyamide, with very particular preference being given to PET, PEN, and polyamide films.

Film 1 may be a monolayer film. Alternatively, it may be a multilayer film. Multilayer films are preferably produced by coextrusion. The layers may be composed of chemically identical, similar or different polymers. For example, a polyvinyl alcohol layer may be embedded between two polyolefin films, or LLDPE combined with LDPE. The term “multilayer films” also embraces laminates of polymer films and metal foils, especially aluminum foils.

The films may also be coated. Examples that may be mentioned here include metallized films, especially films vapor coated with Al, or films (vapor) coated with SiO₂.

For film 2 it is possible to use polymer films, including metallized polymer films, or metal foils. Suitable polymer films include in particular the materials disclosed for film 1. As metal foils use is made in particular of aluminum foils, although it is also possible, for example, for these foils to be tin foils, copper foils or gold foils.

Particularly preferred multilayer materials comprise at least one polar film in combination with an apolar film. Examples that may be mentioned include laminates of polyamide films or polyester films with polyolefin films, especially polyethylene or polypropylene films. Further preference is given to multilayer materials of polyamide and polyester films or to laminates containing in each case only polyamide or only polyester films.

The multilayer material of the invention further comprises at least one print layer which is obtainable by printing or coating at least one of the films with a printing ink.

The printed layer may be on the outside of the multilayer material. Preferably, however, the print layer is between the two films, i.e., embedded in the laminate. The print layer may lie directly on one of the films or there may be one or more other layers between the film and the print layer. The print layer is preferably printed directly either onto film 1 or onto film 2.

The multilayer material may also comprise two or more print layers. With preference, all of the print layers include a hyperbranched .polyurea containing the functional groups defined at the outset. The minimum requirement, however, is that at least one of the print layers contains said polyurea. The print layers may be printed over one another. For example, first a primer, with a white color, for example, may be printed onto a film, followed by a second layer with a single- or multicolor decoration. Alternatively, the primer can be printed onto one film and the decoration onto the other film, or else the primer onto one side and the decoration onto the other side of the same film.

Of course, a multilayer laminate may also include further films in addition to films 1 and 2. The sequence of the films in the laminate is determined by the skilled worker in accordance with the desired properties and the intended use of the multilayer material.

The multilayer material may also comprise additional layers with which in each case particular properties can be achieved. Mention ay be made here in particular of adhesive layers, which can be used to join some or all of the layers to one another. Further, it is possible to incorporate additional barrier layers. By way of example, polyvinyl alcohol layers or ethylene-polyvinyl alcohol layers may be incorporated as water vapor barriers. It is also possible to instal odor or aroma barriers. Suitable materials for this purpose are disclosed, for example, in EP-A 707 956 or EP-A 802 045.

The multilayer material may also include layers of printing varnishes, for the purpose, for example, of priming the films or as a protective coating. For this purpose it is possible on the one hand to use conventional printing varnishes. With particular advantage, however, the printing varnishes used are those comprising as binder at least one hyperbranched polyurea containing functional groups selected from the group consisting of amino, OH, and blocked isocyanate groups.

The print layers in the multilayer material are obtainable by printing or coating the films with an appropriate printing ink. Printing is carried out preferably by means of flexographic or gravure methods, although screenprinting can be used in special cases.

Particularly suitable printing inks are packaging inks for flexographic or gravure printing. The term “printing inks for packaging” is both self-explanatory and restrictive. Printing inks for packaging are fast-drying printing inks of low viscosity. Accordingly, they contain relatively low-boiling solvents. The boiling point is generally not more than 140° C. Screenprinting inks are formulated in much the same way as flexographic or gravure inks but are adjusted to a slightly higher viscosity and normally contain solvents with somewhat higher boiling points.

In accordance with the invention, the printing ink comprises as binder a hyperbranched polyurea containing functional groups selected from the group consisting of amino, OH, and blocked isocyanate groups. The term “binder” as well is self-explanatory and at the same time restrictive. Binders are one of the principal constituents of printing inks and are responsible for the actual formation of a film. They provide for the anchoring of pigments and fillers in the ink film and for adhesion to the substrate, and are used in the amount necessary to achieve this effect.

Polyureas can generally be obtained from isocyanates with a functionality of at least two and primary or secondary amines with a functionality of at least two.

The present invention is performed with hyperbranched polyureas in the actual sense, i.e., molecularly and structurally nonuniform polyureas.

For performing the invention it is preferred to use pure polyureas, i.e., compounds containing only urea linkages. Naturally, such polymers may to a minor extent include linkages which come about as a result of secondary reactions which are not actually required but are unavoidable. The invention, however, also embraces the use of hyperbranched polymers which contain a certain fraction of urethane linkages. Generally, however, at least 70% of all the linkages in the polymer are urea bonds, preferably at least 80%, and with very particular preference at least 90%.

The hyperbranched polyureas may be synthesized preferably as set out below, without wishing the invention to be restricted to the use of the polyureas synthesized by that method.

In the case of the preferred synthesis, diisocyanates or polyisocyanates containing blocked NCO groups are reacted with difunctional or polyfunctional primary and/or secondary amines in a two-stage synthesis.

In blocked or capped isocyanates, the isocyanate groups have been reacted with blocking reagents. A feature of blocking reagents is that they ensure the thermally reversible blocking of the isocyanate groups at temperatures of generally below 160° C. Blocking agents which can be used include, for example, aliphatic alcohols, phenols, caprolactam, 1H-imidazole, 2-methylimidazole, 1,2,4-triazole, 3,5-dimethylpyrazole, dialkyl malonates, acetanilide, acetone oxime, and butanone oxime. Preferred blocking agents for the present synthesis include linear and branched aliphatic monoalcohols, such as methanol, ethanol, propanol, butanol, pentanol, hexanol, heptanol, octanol, isopropanol, isobutanol or 2-ethyl-1-hexanol, and araliphatic monoalcohols, such as benzyl alcohol or phenylethanol. Particular preference is given to butanol, isopropanol, and benzyl alcohol. Blocking lowers the reactivity of the isocyanate but increases the selectivity for reaction with amino groups of different reactivity, and so allows a controlled reaction.

In a first synthesis step, (A), at least one difunctional blocked diisocyanate or polyisocyanate is reacted with at least one at least difunctional primary and/or secondary amine, with the elimination of the blocking agent. The proportions of the starting products are chosen so as to produce ABₓ monomers which contain not only blocked isocyanate groups but also primary and/or secondary amino groups that are reactive with them. x is a natural number between 2 and 8. Preferably, x is 2 or 3. Either A comprises the blocked isocyanate groups and B the amino groups, or vice versa.

In the second synthesis step, (B), the resulting ABₓ monomers are reacted intermolecularly to give a hyperbranched polyurea.

The synthesis may take place advantageously without isolation of the ABₓ monomers. The separation between the individual synthesis steps comes about through the reaction temperature. The synthesis of the ABₓ monomers from the starting materials is performed first of all at a relatively low temperature, from 20 to 80° C. for example. The polymerization is then performed by heating the mixture to higher temperatures, from 90 to 160° C. for example.

Examples of suitable diisocyanates and/or polyisocyanates are, in particular, readily and inexpensively available isocyanates, such as aromatic isocyanates like tolylene 2,4-diisocyanate (2,4-TDI), diphenylmethane 2,4′-diisocyanate (2,4′-MDI), triisocyanatotoluene, or aliphatic isocyanates, such as hexamethylenediisocyanate (MDI), isophorone diisocyanate (IPDI), 2-butyl-2-ethylpentamethylene diisocyanate, 2-isocyanatopropylcyclohexyl isocyanate, 2,4,4- or 2,2,4-trimethylhexamethylene diisocyanate, methylenebis(cyclohexyl) 2,4′-diisocyanate and 4-methylcyclohexane 1,3-diisocyanate (H-TDI). It is of course also possible to use mixtures of said isocyanates.

The amines are selected from compounds which carry at least two primary and/or secondary amine groups which are reactive with blocked isocyanate groups. Examples include aliphatic or araliphatic diamines such as ethylenediamine, butylenediamine, N-alkylbutylenediamine, hexamethylenediamine, N-alkylhexamethylenediamine or tolylenediamine, aliphatic or araliphatic triamines, such as bis(aminoethyl)amine, bis(aminopropyl)amine, bis(aminobutyl)amine, bis (aminopentyl ) amine, bis (aminohexyl ) amine, tris(aminoethyl)amine, tris(aminopropyl)amine, tris(aminohexyl)amine, or trisaminohexane. It is also possible, furthermore, to use any desired mixtures of at least two of said compounds.

In the synthesis of the ABₓ molecules it is also possible with advantage to use blocked isocyanates and amines which each contain groups of different reactivity. Through the choice of suitable conditions, such as suitable temperatures, it is possible to bring first the more reactive amino groups and/or more reactive blocked isocyanate groups to reaction with one another, while the less reactive groups are preferably unreacted. They react not until a later reaction phase: when the temperature is raised, for example.

Examples of blocked diisocyanates containing groups of different reactivity include isophorone diisocyanate (IPDI), tolylene 2,4-diisocyanate (2,4-TDI) or diphenylmethane 2,4′-diisocyanate (2,4′-MDI). Further examples include those diisocyanates whose blocked NCO groups start out with equal reactivity but in which, through reaction of the first blocked NCO group, it is possible to induce a fall in reactivity for the second group. Examples thereof are isocyanates whose NCO groups are coupled via a delocalized p electron system, e.g., phenylene 1,4-diisocyanate, naphthylene 1,5-diisocyanate or tolylene 2,6-diisocyanate.

Examples of amines containing groups of different reactivity are those which contain primary and secondary amino groups, such as N-alkylbutylenediamine or bis(aminoethyl)amine.

The preparation of an AB₂ molecule may be illustrated by way of example for the case of the reaction of a blocked diisocyanate with a triamine. Blocking of the diisocyanate may be performed in a particularly elegant way by using the alcohol blocking agent as a solvent for the reaction as well and adding the isocyanate to the alcohol dropwise. The temperatures in this case should remain below 160° C., preferably below 100° C. It is also possible, naturally, to synthesize the blocked isocyanate in a separate reaction. 1 mol of the blocked diisocyanate is reacted with 1 mol of a triamine containing 2 primary amino groups and one secondary amino group, an example being diethylenetriamine or dihexamethylenetriamine. The more basic, secondary amino group of the amine reacts preferentially with the blocked isocyanate groups, while the primary groups as yet undergo substantially no reaction. The AB₂ molecule formed has one blocked NCO group and two free NH₂ groups. The AB₂ molecule may then be polycondensed to give a hyperbranched polyurea.

An AB₂ molecule having two blocked NCO groups and one amino group may be synthesized, for example, from 1 mol of an amine having 3 primary amino groups and 2 mol of a blocked isocyanate. The necessary selectivity can be achieved, for example, by using a blocked isocyanate containing NCO groups of differing reactivity.

The polymerization may be conducted without solvent or in an appropriate solvent. A particularly suitable solvent is the alcohol blocking agent itself, such as butanol, for example. In order to accelerate the reaction it is possible to add appropriate catalysts, such as diazabicyclooctane or dibutyltin dilaurate, for example. The molecular weight of the hyperbranched polyurea may be regulated in particular by way of the reaction temperature and reaction time in the course of the polycondensation of the ABₓ molecules.

After the reaction the hyperbranched polyureas formed by the process described are terminated either with amino groups or with blocked NCO groups. Depending on the nature of the amine used, the amino groups are NH₂ groups or else NHR groups, with R preferably being a C₁-C₆ alkyl group. NH₂ groups are preferred.

Other products are available through further synthesis variants.

Hyperbranched polyureas with chain-extended arms can be obtained, for example, by adding to the polymerization reaction in addition to the ABₓ molecules, in a molar ratio of 1:1, a blocked diisocyanate or a diamine.

OH-containing polyureas for the printing ink of the invention may be obtained, for example, by subsequent modification of the hyperbranched polyurea obtained. With particular preference this modification takes place without isolation of the polymer beforehand. By way of example, a hyperbranched polyurea containing blocked isocyanate terminal groups can be reacted with suitable OH groups. Particularly suitable for this purpose are compounds containing amino groups and OH groups. Since the amino groups are much more reactive than the compounds containing OH groups, it is almost exclusively the amino groups which react in the case of such molecules. Examples of suitable compounds include ethanolamine, N-methylethanolamine, propanolamine, isopropanolamine, 2-(butylamino)ethanol, 2-(cyclohexylamino)ethanol, 2-amino-1-butanol, 2-(2′-aminoethoxy)ethanol or higher alkoxylation products of ammonia, 4-hydroxypiperidine, 1-hydroxyethylpiperazine, diethanolamine, dipropanolamine, diisopropanolamine, tris(hydroxyinethyl)aminomethane or tris(hydroxyethyl)aminomethane.

In this case it is possible for all of the blocked isocyanate groups to be reacted, so that the modified polyurea contains only OH groups as terminal groups. However, it is also possible for only some of the blocked isocyanate groups to be reacted. In this way, products are obtained which contain both blocked isocyanate groups and OH groups. Hyperbranched polyureas containing OH, amino, and blocked isocyanate end groups may be obtained through the use of a mixture of primary and/or secondary diamines and amino alcohols for the concluding functionalization.

It is also possible, however, for OH groups to be incorporated pendantly, by using appropriate building blocks. For example, chain extension can be performed using diamines which also possess one OH group, e.g., 1,3-diamino-2-propanol. In another approach, some of the triamine for the aforementioned synthesis of the AB₂ molecule may be replaced by an amino dialcohol, such as by bis(aminoethyl)amine, bis(aminopropyl)amine or bis(aminohexyl)amine, for example. This produces AB₂ molecules which contain one blocked isocyanate group and two OH groups. Condensation with AB₂ molecules containing blocked isocyanate and amino groups produces polymers which contain OH groups pendantly and terminally. In addition to the urea links, polymers of this kind may also contain urethane links.

Further synthesis variants are disclosed in our as yet unpublished German application DE 102 04 979.3.

The molar mass is chosen by the skilled worker in accordance with the type of application that is intended. Products which have proven appropriate are those having a weight-average M_{W} of from 750 to 40 000 g/mol, preferably from 1000 to 20 000 g/mol, and with particular preference from 1500 to 8000 g/mol.

The uniformity of the hyperbranched polyureas may be indicated conventionally through the ratio M_{w}/Mₙ. M_{w}/Mₙ is generally from 1.2 to 40, preferably from 1.3 to 20, and with very particular preference from 1.5 to 10.

For the purposes of the present invention, the hyperbranched polyureas may also be used as a mixture with other binders, provided that the mixture does not cause any unwanted effects, such as instances of precipitation, for example. Examples of further binders for the printing ink of the invention include polyvinylbutyral, nitrocellulose, polyamides, polyacrylates or polyacrylate copolymers. The combination of the hyperbranched polyureas with nitrocellulose has proven particularly advantageous. The total amount of all binders in the printing ink of the invention is normally 5-35% by weight, preferably 6-30% by eight, and with particular preference 10-25% by weight, based on the sum of all the constituents. The ratio of the amounts of hyperbranched polyurea to the total amount of all binders is normally 30/100 to 1, preferably 40/100-1, although the amount of hyperbranched polyurea should not fall below generally 3% by eight, preferably 4% by weight, and with particular preference 5% by weight with respect to the sum of all of the constituents of the printing ink.

Either a single solvent or else a mixture of two or more solvents can be used. Solvents suitable in principle are the customary solvents for printing inks for packaging. Particularly suitable solvents for the printing ink of the invention are alcohols such as ethanol, 1-propanol, 2-propanol, ethylene glycol, propylene glycol, diethylene glycol, substituted alcohols such as ethoxypropanol, esters such as ethyl acetate, isopropyl acetate, n-propyl or n-butyl acetate. A further solvent suitable in principle is water. Particular preference as solvents is given to ethanol and to mixtures composed predominantly of ethanol. Among the solvents which are possible in principle, the skilled worker will make an appropriate selection in accordance with the solubility properties of the polyurea and the desired properties of the printing ink. It is normal to use from 40 to 80% by weight of solvent, based on the sum of all the constituents of the printing ink.

As colorants it is possible to use the customary coloring substances, especially customary pigments. Examples are inorganic pigments such as titanium dioxide pigments or iron oxide pigments, interference pigments, carbon blacks, metal powders such as particularly aluminum, brass or copper powders, and also organic pigments such as azo, phthalocyanine or isoindoline pigments. It is of course also possible to use mixtures of different dyes or pigments, and also soluble organic dyes. It is normal to use. from 5 to 25% by weight of colorant, based on the sum of all the constituents.

The printing ink of the invention may optionally comprise further additives and auxiliaries. Examples of additives and auxiliaries are fillers such as calcium carbonate, aluminum oxide hydrate or aluminum and/or magnesium silicate. Waxes increase the abrasion resistance and serve to raise the lubricity. Examples are, in particular, polyethylene waxes, oxidized polyethylene waxes, petroleum waxes or ceresin waxes. Fatty acid amides can be used to increase the surface smoothness. Plasticizers serve to increase the elasticity of the dried film. Examples are phthalates such as dibutyl phthalate, diisobutyl phthalate or dioctyl phthalate, citric esters or esters of adipic acid. For dispersing the pigments it is possible to use dispersing auxiliaries. With the printing ink of the invention it is possible with advantage to forego the use of adhesion promoters, although this fact is not intended to rule out the use of adhesion promoters. The total amount of all additives and auxiliaries does not normally exceed 20% by weight of the sum of all the constituents of the printing ink, and is preferably 0-10% by weight.

The printing ink of the invention can be prepared in a manner which is known in principle, by intensive mixing and/or dispersing of the constituents in customary apparatus such as dissolvers, stirred ballmills or a triple-roll mill, for example. First of all, advantageously, a concentrated pigment dispersion is prepared with a portion of the components and with a portion of the solvent, and is subsequently processed further with additional constituents and additional solvent to give the finished printing ink.

The printing varnishes of the invention naturally do not contain colorants, but apart from that contain the same constituents as the printing inks outlined above. The amounts of the other components are increased accordingly.

The print layer obtainable with the printing ink has essentially the same composition as the printing ink, except that some or all of the solvent and any volatiles present undergo evaporation.

The print layers exhibit outstanding adhesion to both polar and apolar substrates. They are particularly suitable for producing multilayer materials with polyamide or polyester films. Multilayer materials comprising these films and the printing ink of the invention exhibit especially good adhesion between the layers.

The invention is described in more detail by the following examples:

Preparation of the Hyperbranched Polyureas

For the invention the following hyperbranched polyureas were used:

### EXAMPLE 1

A reaction vessel with stirrer, internal thermometer, and nitrogen inlet tube was charged under dry nitrogen blanketing with 10 mol of anhydrous n-butanol, and 1000 ppm (based on isocyanate) of diazabicyclooctane were added. The solution was then heated to 60° C. and 1 mol of tolylene diisocyanate (TDI) was added at a rate such that the temperature of the reaction mixture did not exceed 70° C. Following the addition of the TDI, stirring was continued at 70° C. for 1 hour. Then 0.5 mol of diethylenetriamine was added, the temperature was raised to 130° C. and reaction was allowed to continue at this temperature for 9 hours. Thereafter the solution was freed from the butanol at 80° C. under reduced pressure in a rotary evaporator.

For GPC analysis, the products were taken up in dimethylacetamide and analyzed in dimethylacetamide as the mobile phase.

The results are correlated in table 1.

### EXAMPLE 2

Hyperbranched Polyurea with Additional OH Groups

A reaction vessel with stirrer, internal thermometer, and nitrogen inlet tube was charged under dry nitrogen blanketing with 10 mol of anhydrous butanol, and 1000 ppm (based on isocyanate) of dibutyltin dilaurate were added. The solution was then heated to 60° C. and 1 mol of isophorone diisocyanate (IPDI) was added at a rate such that the temperature of the reaction mixture did not exceed 70° C. Following the addition of the IPDI, stirring was continued at 70° C. for 1 hour. Then a mixture of 0.438 mol of diethylenetriamine and 0.125 mol of diethanolamine was added and the temperature was increased to 125° C. for 10 hours and then to 135° C. for a further 10 hours. Thereafter the solution was freed from the butanol at 80° C. under reduced pressure in a rotary evaporator.

For GPC analysis, the products were taken up in dimethylacetamide and analyzed in dimethylacetamide as the mobile phase. The results are correlated in table 1.

### EXAMPLE 3

Subsequent Modification of the End Groups

A reaction vessel with stirrer, internal thermometer, and nitrogen inlet tube was charged under dry nitrogen blanketing with 10 mol of dry butanol, and 1000 ppm (based on isocyanate) of dibutyltin dilaurate were added. The solution was then heated to 60° C. and 1 mol of IPDI was added at a rate such that the temperature of the reaction mixture did not exceed 70° C. Following the addition of the isocyanate, stirring was continued at 70° C. for 1 hour. Then 0.5 mol of diethylenetriamine was added, the temperature was raised to 125° C. and reaction was allowed to continue at this temperature for 10 hours. The temperature was then raised to 135° C. and stirring was continued at that temperature for 10 hours. Then 0.5 mol of diethanolamine were added and stirring was continued at 135° C. for a further 5 hours. Thereafter the solution was freed from the butanol at 80° C. under reduced pressure in a rotary evaporator.

For GPC analysis, the product was taken up in dimethylacetamide and analyzed in dimethylacetamide as the mobile phase.

TABLE 1
Summary of results

| | | | | | Product, | |
|---|---|---|---|---|---|---|
| | | | | | molecular weight | |
| | | | | | from GPC data | |
| | | Amine or | | | (PMMA | |
| | | amine | Time/ | End group | calibration) | |
| No. | Isocyanate | mixture | Temperature | modification | Mw | Mn |
| 1 | 1 mol | diethylenetriamine | 9 h at | no | 4410 | 2500 |
| | TDI | | 130° C. | | | |
| 2 | 1 mol | 0.438 mol | 10 h at | no | 3680 | 2290 |
| | IPDI | diethylenetriamine + 0.125 mol | 125° C. and | | | |
| | | diethanolamine | 10 h at | | | |
| | | | 135° C. | | | |
| 3 | 1 mol | 0.5 mol | 10 h at | with | 4230 | 2110 |
| | IDPI | diethylenetriamine | 125° C. and | 0.5 mol | | |
| | | | 10 h at | diethanolamine | | |
| | | | 135° C. | 5 h, 135° C. | | |

Preparation of Printing Inks

A number of flexographic printing inks were prepared by intensively mixing the following components:

| | |
|---|---|
| 70.0 | Pigment preparation (BASF Drucksysteme) |
| 6.0 | Hyperbranched polyurea |
| 8.0 | Nitrocellulose (Wolf) |
| 1.0 | Oleamide (Croda) |
| 0.5 | PE waxes (BASF AG) |
| 2.0 | Dibutyl phthalate (Brenntag) |
| 10.5 | Ethanol |
| 2.0 | Titanium chelate adhesion promoter (Du Pont) |

A second series was carried out using the same components but leaving out the adhesion promoter. For comparative purposes, moreover, flexographic printing inks were prepared using conventional PU binders (PUR 7313 (BASF)), which are normally used for this purpose in the prior art. The formulations are summarized in table 2:

TABLE 2
Composition of the test printing inks

| No. | Binder | Adhesion promoter |
|---|---|---|
| Printing ink 1 | as per Example 1 | yes |
| Printing ink 2 | as per Example 1 | no |
| Printing ink 3 | as per Example 2 | yes |
| Printing ink 4 | as per Example 2 | no |
| Printing ink 5 | as per Example 3 | yes |
| Printing ink 6 | as per Example 3 | no |
| Printing ink 7 | conventional PU | yes |
| | binder | |
| | (PUR 7313 (BASF)) | |
| Printing ink 8 | conventional PU | no |
| | binder | |
| | (PUR 7313 (BASF)) | |

Adhesion to Substrates

The adhesion of the of the invention to polar films of polyamide and PET and to an apolar film of PP was measured.

Measurement Method:

The “tesa strength” test method is used to determine the adhesion of a film of printing ink to the print substrate.

Implementation of the Test

The ink diluted to printing viscosity is printed onto the respective film or drawn down using a 6 μm doctor blade. A strip of tesaband (adhesive tape with a width of 19 mm (Article BDF 4104, Beiersdorf AG) is stuck onto the printing ink film, pressed down uniformly and torn off again after 10 seconds. This procedure is repeated 4 times on the same area of the test specimen, in each case using a new strip of tape. Each strip of tape is stuck successively onto a piece of white paper or, in the case of white inks, onto black paper. Testing is carried out immediately following application of the ink.

Evaluation

A visual examination is made of the surface of the test specimen for damage. The score awarded ranges from 1 (very poor) to 5 (very good). Tables 3 and 4 summarize the results of the tests.

TABLE 3
Test results with printing inks containing adhesion promoter

| | PP film | PET film | Polyamide film |
|---|---|---|---|
| | (MB 400) | (Melinex 800) | (Walomid XXL) |
| Printing ink 1 | 5 | 5 | 2 |
| Printing ink 3 | 5 | 4 | 1 |
| Printing ink 5 | 5 | 4 | 1 |
| Printing ink 7 | 5 | 3 | 1 |
| (comparative) | | | |

TABLE 4
Test results with printing inks containing no adhesion promoter

| | PP film | PET film | Polyamide film |
|---|---|---|---|
| | (MB 400) | (Melinex 800) | (Walomid XXL) |
| Printing ink 2 | 5 | 5 | 2 |
| Printing ink 4 | 5 | 4 | 1 |
| Printing ink 6 | 5 | 4 | 1 |
| Printing ink 8 | 1 | 1 | 1 |
| (comparative) | | | |

Production of Composite Materials

Using printing inks 1 to 8, multilayer materials were produced with different films. The quality of the laminates is determined by measuring the adhesion between two films joined by laminating.

### EXAMPLES 4-10

General Procedure

The ink diluted to printing viscosity is printed onto film 1 as substrate. In parallel, the laminating film (film 2) is coated with an adhesive/hardener mixture (R & H MOR-FREE A 4123/hardener C 88)) so as to give a film thickness of approximately 6 μm. The two films are then pressed to one another so that the printing ink and the adhesive come into contact. After pressing together, the composite films are stored at 60° C. for three days and then the laminate strength is measured. The results of the tests are summarized in table 5.

Test Method:

Measurement and Testing Apparatus: Zwick Tensile Tester Punching Tool (Width: 15 mm)

At least two strips (width: 15 mm) in each case are cut longitudinally and transversely to the film width from the composite material under test. In order to make it easier for the laminate to separate (delamination), the ends of the punched-out strips can be immersed in a suitable solvent (e.g. 2-butanone) until the materials part from one another. Thereafter the specimen is carefully dried. The delaminated ends of the test specimens are clamped into the tensile strength tester. The less extensible film is inserted into the upper jaw. When the machine is started, the end of the specimen should be held at right angles to the direction of tension, thereby ensuring constant tension. The rate of peel is 100 mm/min, the peel angle of the separated films to the unseparated complex 90°.

Evaluation:

The laminate strength is read off as the mean value, and reported in N/15 mm.

TABLE 5
Results for the composites, polyamide film: Walomid XXL,
PET film: Melinex 800, PP film: MB 400

| | | | | | Lami- |
|---|---|---|---|---|---|
| | | Film 2 | | | nate |
| | Film 1 | Lami- | | | strength |
| | Print | nating | | Adhesion | (N/15 |
| Example | substrate | film | Printing ink | promoter | mm) |
| Example 4 | polyamide | PE | printing ink 1 | yes | 7.7 |
| Example 5 | polyamide | PE | printing ink 2 | no | 9.5 |
| Example 6 | PET | PE | printing ink 1 | yes | 4.5 |
| Example 7 | PET | PE | printing ink 2 | no | 3.2 |
| Example 9 | PP | PE | printing ink 1 | yes | 3.3 |
| Example 10 | PP | PE | printing ink 2 | no | 4.2 |
| Comparative | polyamide | PE | printing ink 7 | yes | <0.5 |
| example 1 | | | | | |
| Comparative | polyamide | PE | printing ink 8 | no | <0.5 |
| example 2 | | | | | |
| Comparative | PP | PE | printing ink 7 | yes | 2.5 |
| example 3 | | | | | |
| Comparative | PP | PE | printing ink 8 | no | <0.5 |
| example 4 | | | | | |

The test results show that the adhesion of the printing inks of the invention even to chemically different film types is significantly improved by the use of the hyperbranched polyureas as compared with conventional binders.

Particularly surprising is the fact that there is no need for adhesion promoters and yet very good results are still obtained.

The advantages in comparison with the prior art are even more clearly pronounced-in the case of the multilayer materials of the invention. With conventional systems, in the case of polar films when the adhesion promoter is omitted, no adhesion at all is obtained. Particularly when using polar films, the multilayer materials of the invention with hyperbranched polyureas exhibit outstanding adhesion.

This result is all the more surprising on account of the fact that the simple adhesive tape tests did not suggest this very good result.

1. A multilayer material for producing packaging, comprising at least
one film 1 of a polymeric material,
one print layer obtainable by printing or coating with a printing ink,
one further film 2,
wherein said printing ink comprises as binder at least one hyperbranched polyurea containing functional groups selected from the group consisting of amino, OH, and blocked isocyanate groups.

2. A multilayer material as claimed in claim 1 wherein the print layer is arranged between the two films.

3. A multilayer material as claimed in claim 1, wherein the print layer is printed directly onto film 1 or film 2.

4. A multilayer material as claimed in claim 1, wherein film 1 is a multilayer film.

5. A multilayer material as claimed in claim 1, wherein film 1 is a film selected from the group consisting of polyethylene, polypropylene, polystyrene, polyester, and polyamide films.

6. A multilayer material as claimed in claim 5, wherein film 1 is a polar film selected from the group consisting of PET, PEN, and polyamide films.

7. A multilayer material as claimed in claim 1, wherein a further film 2 is a film selected from the group consisting of polymer films, including metallized polymer films, and metal foils.

8. A multilayer material as claimed in claim 7, wherein film 2 is a polyolefin film.

9. A multilayer material as claimed in claim 1, further comprising an odor barrier layer.

10. A multilayer material as claimed in claim 1, further comprising one or more adhesive layers.

11. A multilayer material as claimed in claim 1, further comprising at least one varnish layer as primer or protector.

12. A multilayer material as claimed in claim 11, wherein the varnish layer comprises as binder at least one hyperbranched polyurea containing functional groups selected from the group consisting of amino, OH, and blocked isocyanate groups.

13. A printing ink for flexographic and/or gravure printing, at least comprising one solvent or a mixture of different solvents, at least one colorant, at least one polymeric binder, and, optionally, additives as well, wherein at least one of the polymeric binders is a hyperbranched polyurea containing functional groups and the functional groups are selected from the group consisting of amino, OH, and blocked isocyanate groups.

14. The use of a printing ink as claimed in claim 13 for printing polymer films or metal foils.

15. The use of a printing ink as claimed in claim 13 for producing multilayer materials.

16. A printing varnish at least comprising at least one solvent or a mixture of different solvents, at least one polymeric binder, and, optionally, additives as well, wherein at least one of the polymeric binders is a hyperbranched polyurea containing functional groups and the functional groups are selected from the group consisting of amino, OH, and blocked isocyanate groups.

17. The use of a printing varnish as claimed in claim 16 for priming polymer films or metal foils or as a protective layer.

18. The use of a printing varnish as claimed in claim 16 for producing multilayer materials.
